(19) United States
(12) Patent Application Publication
(10) Pub. No.: US 2019/0286876 A1
(43) Pub. Date: Sep. 19, 2019

(54) On-Demand Outdoor Image Based Location Tracking Platform

(71) Applicant: Bridgewest Ventures LLC, San Diego, CA (US)

(72) Inventor: Saeid Safavi, San Diego, CA (US)

(21) Appl. No.: 16/355,443

(22) Filed: Mar. 15, 2019

Related U.S. Application Data
(60) Provisional application No. 62/643,501, filed on Mar. 15, 2018.

(51) Int. Cl. G06K 9/00; G06T 7/70; B64C 39/02

(52) U.S. Cl. CPC G06K 9/0063; B64C 2201/123; B64C 39/024; G06T 7/70

(57) ABSTRACT

An image processing system comprising several drones flown over a geographic region is disclosed. The geographic region may be within the cell coverage area of a cellular transmission tower. The cellular transmission tower may be capable of communicating over a cellular telephone network with a cellular telephone transceiver within a lead drone. One or more of the drones may have a camera capable of taking a relatively high resolution photograph of the earth and the features on the earth below the drones. The area of the earth that the camera can capture may include the area directly under each of the other drones. The image can then be compared to other images. Using image recognition algorithms, the processor can identify a target asset and track the target asset based on the comparison of images.

### CROSS-REFERENCE TO RELATED APPLICATIONS—CLAIM OR PRIORITY

The present application claims priority to U.S. Provisional Application No. 62/643,501, filed on Mar. 15, 2018, entitled “On-Demand Outdoor Image Based Location Tracking Platform”, which is herein incorporated by reference in its entirety.

### BACKGROUND

### (1) Technical Field

Systems and methods for controlling a smart home, office or other occupied environment.

### (2) Background

The demand for accurate location tracking has been greatly increasing due to a variety of location-based applications that are becoming important in light of the rise of smart cities, connected cars and the “Internet of Things” (IoT), among other applications. People are using position location for everything from tagging the location at which pictures were taken to personal navigation. In most cases, the means used by applications that need to know the location of a device requires access to the Global Positioning System (GPS). Other competing global navigation satellite systems also exist, such as GLONASS, et al. However, a major draw-back to such global navigation satellite systems, such as the current GPS based systems, is that they all need a relatively sensitive GPS receiver located on the tracked object. This is not necessarily the efficient, practical or otherwise viable, particularly in critical situations like security threats or emergency scenarios, such as natural disasters, etc. Furthermore, there are situations in which it is difficult to receive the necessary signals transmitted by the satellites of the current global navigation satellite systems. Therefore, there is a need for a system for locating and tracking assets (e.g., objects and people) without the need to have a transmitter or receiver on the tracked asset.

### DESCRIPTION OF THE DRAWINGS

FIG. 1 is an illustration of one example of a system in accordance with the disclosed method and apparatus.

Like reference numbers and designations in the various drawings indicate like elements.

### DETAILED DESCRIPTION

The presently disclosed method and apparatus uses image processing technology, including hardware and software algorithms and platforms associated with them, together with the artificial intelligence (AI) to locate assets (e.g., objects, people, etc.). Image processing-based technology can be used for accurate localization and other smart city location-based services, without the need for a device on the tracked asset.

The disclosed method and apparatus uses a collection of outdoor cameras on fixed or mobile platforms (such as drones). Each such outdoor camera resides at a predefined location. Such outdoor cameras take pictures of a scene, a person, or an object. Though “image fitting” with an map of the area in which the asset to be located or tracked resides, the area within the picture can be correlated to the image of an area map. The asset can then be identified within the image and accurately located with respect to the other features of the picture and the correlation of the image to the image of the area map.

This method and apparatus can be used to identify, locate and track an asset. In addition, several useful applications can be implemented using this technique, such as identifying situations and opportunities, such as identifying the location of an empty parking space, finding a particular building without the need for an address (based on an image of the building or an image that is on or near the building, such as a sign with the name of the company that occupies the building.

This technique involves sophisticated image processing algorithms that attempt to do pattern matching and 3D image rotation to find the best fit. Upon finding a “best fit”, the system can location of a “target asset”. Other technologies such as facial feature recognition, object detection etc. may also be used depending on the particular application of the method and apparatus (e.g., whether locating missing objects, such as a lost car, identifying an empty parking space, finding a desired person, etc.). The disclosed method and apparatus may be used to make use of drone cameras for localization (through localization by map matching). In addition, the disclose method and apparatus may be used for equipping the drone with an accurate location tracking system so that the location of the drone can be independently determined (e.g. using combined GPS and terrestrial triangulation or through drone triangulation). It should be noted that depending upon certain parameters, the image attained from the camera may be sufficient to determine the location of the camera without an independent source of information regarding the location of the camera. That is, correlating the image from the camera with map data for the area, which may include a previously captured image of the area, the camera may be located. Alternatively, the location of the camera may not be necessary, if a library of images that include the area around the camera can be accessed. In that case, identifying the asset of interest in the image taken by the camera and correlating the image with an image that has known locations pre-identified can provide sufficient information to identify both the location of the camera and the location of the asset of interest.

The tracked object or present is localized by taking the snapshots of the field of view, rotating the image to fit on a map template (e.g., google maps) and deducting the object location by image recognition.

The disclosed method and apparatus can provide very accurate real time location information about a target asset. In addition, the disclosed method and apparatus can find a specific object or person by matching the images taken to a database and using object or pattern recognition algorithm to locate the target asset. After locating the target asset, the system can follow the target asset across a field of view. In some embodiments in which a drone is used to support the camera, the drone can move accordingly to attain and maintain a field of view.

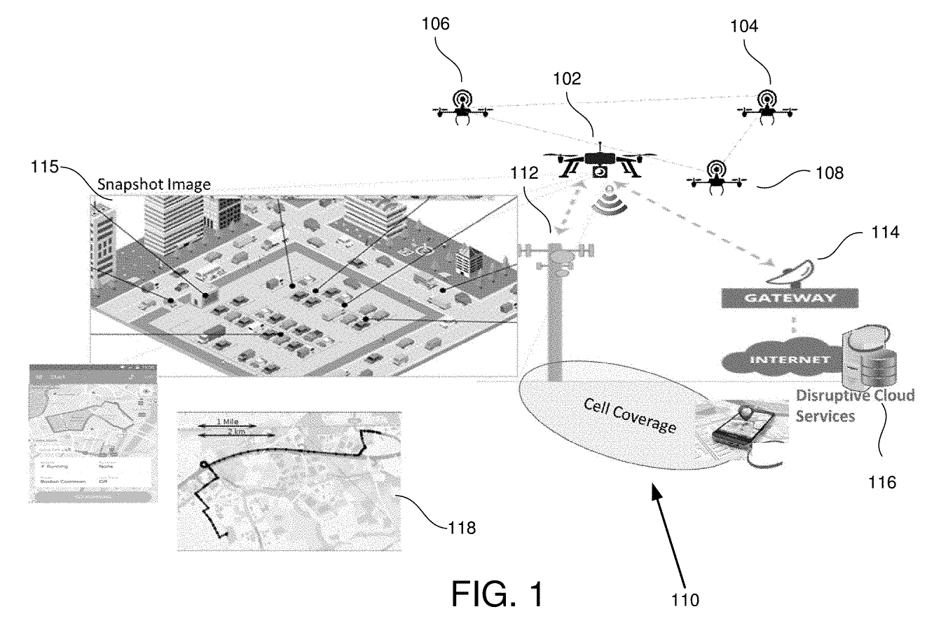

FIG. 1 is an illustration of one example of a system in accordance with the disclosed method and apparatus. In the example of FIG. 1, several drones 102, 104, 106, 108 are flown over a geographic region 110. In some embodiments, the geographic region is within the cell coverage area of a cellular transmission tower 112. The cellular transmission tower is capable of communicating over a cellular telephone network with a cellular telephone transceiver within a lead drone 102. One or more of the drones 102, 104, 106, 108 has a camera capable of taking a relatively high resolution photograph of the earth and the features on the earth below the drones 102, 104, 106, 108. The area of the earth that the camera can capture may include the area directly under each of the other drones. Alternatively, the image taken by the camera may capture the geographic region under only a subset of the other drones 104, 106, 108. Furthermore, the drones 104, 106, 108 may be outside the area captured by the image taken with the camera in the lead drone 102. Nonetheless, in some embodiments, each of the drones 104, 106, 108 can communicate with the lead drone 102. In some such cases, each drone 102, 104, 106, 108 can communicate with each other drone 102, 104, 106, 108. Such communication may be over the cellular telephone network or over a local area network. Other communication systems can be used as well with alternative embodiments.

In some embodiments, the lead drone 102 may also communicate with an internet gateway 114. The internet gateway 114 provides a means by which the image 115 taken by the camera within the lead drone 102 (and possible images taken by cameras within the other drones 104, 106, 108) can be transmitted to a processor 116 or other resources within the cloud over the internet. The image can then be compared to another image 118, such as an image taken by a satellite (not shown). Using image recognition algorithms, the processor 116 within the cloud can then identify a target asset, such a person running a marathon and track the target asset based on the comparison of images captured by the camera within the drones 102, 104, 106, 108 and images and other feature data known to the processor 116 by independent means.

What is claimed is:

1. An image processing system, comprising:
(a) a collection of outdoor cameras on fixed or mobile platforms; and
(b) a processor within a cloud connected to the internet and in communication with the collection of outdoor cameras, the processor configured to use images received from the collection of outdoor cameras and compare the received images to other images taken by a satellite and to use image recognition algorithms to identify a target asset and track the target asset based on the comparison of images captured by at least one of the collection of outdoor cameras.
